(19) United States
(12) Patent Application Publication
(10) Pub. No.: US 2025/0327485 A1
(43) Pub. Date: Oct. 23, 2025

(54) MANUFACTURING METHOD OF TRACK RACE OF TRIPOD CONSTANT VELOCITY JOINT

(71) Applicant: ERAE AMS CO., LTD, Daegu (KR)

(72) Inventors: Dal Soo JANG, Daegu (KR); Kwang Jin LEE, Daegu (KR)

(73) Assignee: ERAE AMS CO., LTD, Daegu (KR)

(21) Appl. No.: 18/281,043

(22) PCT Filed: Feb. 28, 2022
(86) PCT No.: PCT/KR2022/002857

§ 371 Date: Feb. 29, 2024

(30) Foreign Application Priority Data
Mar. 10, 2021 (KR) 10-2021-0031594

(51) Int. Cl. F16D 3/205; B21D 53/10; F16C 29/02

(52) U.S. Cl. CPC F16D 3/2055; B21D 53/10; F16C 29/02; F16D 2250/0023; F16D 2250/0053

(57) ABSTRACT

In a manufacturing method of a track race disposed between a housing and a spider of a tripod constant velocity joint and having a ball groove an opening of which is narrowed, an end section for forming the narrowed opening of the ball groove is formed on an intermediate workpiece for manufacturing the track race through machining process or plastic deformation process.

### TECHNICAL FIELD

The present invention relates to a method for manufacturing a track race of a tripod constant velocity joint used to transmit driving force of a vehicle.

### BACKGROUND ART

A constant velocity joint is used to transmit a driving force generated by a vehicle's driving device, such as an engine, to a wheel. A tripod constant velocity joint is a type of constant velocity joint that allows axial displacement and is classified as a plunging type. Such a tripod constant velocity joint is primarily used as an inboard joint of a vehicle's drive shaft, and is required to have features of reduced internal friction for improved NVH (Noise, Vibration, and Harshness) performance of a vehicle and compact size to be fitted within a limited space inside a vehicle.

A tripod constant velocity joint generally comprises of a housing having three grooves, an inner joint member (also referred to as a spider) having three journals protruding radially, and three roller units, each engaged to a journal. Typically, the roller unit comprises an outer roller and an inner roller in a shape of a ring, and a needle bearing disposed between the outer and inner rollers. This type of roller unit has inherent limitations in terms of a reduction of an internal friction and a size reduction.

The tripod constant velocity joint used as an inboard joint requires reduced internal friction for the improvement of a vehicle's NVH (Noise, Vibration, and Harshness) performance and miniaturization due to the limited internal space of the vehicle. To meet these requirements, there is a demand for the invention of a new structure and an efficient manufacturing method. In particular, there is a need for structural improvement and a manufacturing method for the unit placed between the journal and the housing that performs the bearing function.
Prior art document: U.S. patent No. U.S. Pat. No. 8,550,924 (2013.10.08.)

### DETAILED DESCRIPTION OF THE INVENTION

### Technical Problem

An object of the present invention is to provide a method for manufacturing a bearing unit of a tripod constant velocity joint that can achieve reduced internal friction while being of a small size. More specifically, an object of the present invention is to provide an efficient method for manufacturing a track race of a bearing unit.

### Technical Solutions

According to an embodiment of the present invention, in a manufacturing method of a track race disposed between a housing and a spider of a tripod constant velocity joint and having a ball groove an opening of which is narrowed, an end section for forming the narrowed opening of the ball groove is formed on an intermediate workpiece for manufacturing the track race through machining process or plastic deformation process.

The end section may be formed through machining using a cutting tool.

The end section may be formed through plastic deformation process by one of a rolling process using a roller, a press process using a press die, or a swaging process using a swaging die.

The manufacturing method may further include performing a hardening heat treatment after the machining process or the plastic deformation process.

A track race according to an embodiment of the present invention is manufactured by an above-described manufacturing method.

A tripod constant velocity joint according to an embodiment of the present invention includes: a housing having a tubular shape that forms three track grooves arranged along a circumferential direction; a spider having a hub placed inside the housing and three journals respectively extending radially outward from the hub and respectively arranged in the track grooves; and three bearing units respectively engaged to the journals. Each of the bearing units comprises a track race that is arranged in the track groove in a state of being tiltably engaged to the journal and a plurality of balls disposed between a peripheral surface of the track race and power transmission surfaces facing each other in a circumferential direction to form the track grooves. The track race comprises a ball groove for at least partially accommodating the plurality of the balls, and the track race is provided with an end section for forming a narrowed opening of the ball groove. The end section is formed by an above-described manufacturing method.

The ball groove may be configured to form a ball circulation path in which the plurality of the balls can circulate along a periphery of the track race.

### Effect of the Invention

According to a manufacturing method of the present invention, it is possible to produce a track race with a reduced opening that features a ball groove, which can efficiently and cost-effectively prevent ball detachment.

### BRIEF DESCRIPTION OF DRAWINGS

FIG. 1 is a perspective view of a tripod constant velocity joint incorporating a track race manufactured by a manufacturing method according to an embodiment of the present invention.

FIG. 2 is a cross-sectional view taken along line II-II of FIG. 1.

FIG. 3 is a cross-sectional view taken along line III-III of FIG. 1.

FIG. 4 is an exploded perspective view of a tripod constant velocity joint of FIG. 1.

FIG. 5 is a front view of a tripod constant velocity joint of FIG. 1.

FIG. 6 is an enlarged view of a portion of FIG. 2.

FIG. 7 illustrates a cross-sectional view cut along a plurality of balls of a bearing unit of a tripod constant velocity joint that includes a track race manufactured according to an embodiment of the present invention.

FIG. 8 is an enlarged view of a portion of FIG. 6.

FIG. 9 is an enlarged view of a portion of FIG. 8, illustrating the diameter d1 of the ball and an entrance height d2 of a track race.

FIG. 10 is a perspective view of a track race of a tripod constant velocity joint manufactured by an embodiment of the present invention.

FIG. 11 is a drawing illustrating a method for machining a ball groove of a track race using a cutting process according to an embodiment of the present invention.

FIG. 12 is a drawing showing a state of a track race before (FIG. 12(a)) and after (FIG. 12(b)) plastic deformation according to a method for forming a ball groove of a track race using plastic deformation in another embodiment of the present invention.

FIG. 13 is a drawing illustrating a method of forming a ball groove of a track race using plastic deformation by a rolling method.

FIG. 14 is a plan view showing a process of forming a curved section and a straight section of a ball groove in a method of forming a ball groove of a track race using plastic deformation by a rolling method.

FIG. 15 is a drawing illustrating a method of forming a ball groove of a track race using plastic deformation by a press method.

FIG. 16 is a drawing illustrating a method for forming a ball groove of a track race using plastic deformation by a swaging method.

### EMBODIMENTS FOR CARRYING OUT THE INVENTION

Hereinafter, embodiments of the present invention will be described in detail with reference to the attached drawings.

In the following, a tripod constant velocity joint in which a track race is applied according to the embodiments of this invention is first described, and subsequently, a manufacturing method for forming a groove in a track race according to embodiments of this invention will be described.

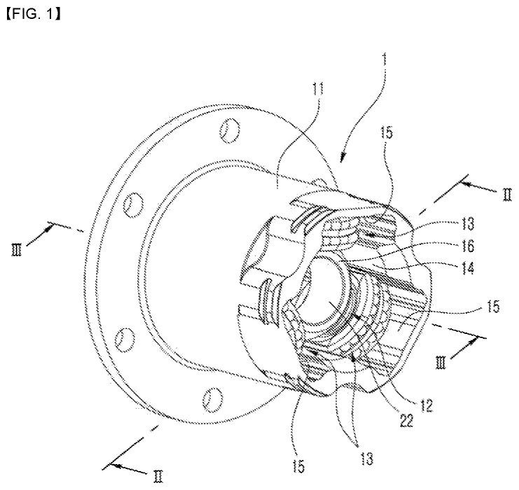

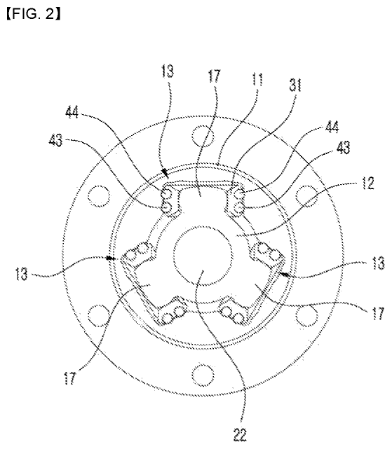

Referring to FIGS. 1 and 2, a tripod constant velocity joint 1 comprises a housing 11, a spider 12, and a bearing unit 13. The housing 11 and the spider 12 may be configured to be respectively connected to power transmission elements, for example, to a power transmission shaft. The bearing unit 13 is positioned between the housing 11 and the spider 12 to serve a role of power transmission medium and bearing functions.

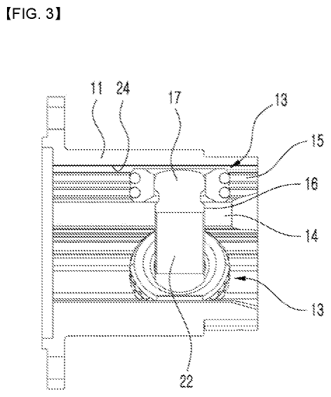

The housing 11 may have a tubular shape that is open on one side in an axial direction. Referring to FIGS. 1 and 3, the housing 11 forms an approximately cylindrical central cavity 14 extending in the axial direction and three track grooves 15 that are evenly spaced in a circumferential direction around the outer circumference of the central cavity 14 and extend parallel to the axial direction.

The spider 12 is positioned inside the housing 11. Referring to FIGS. 1 and 2, the spider 12 comprises a hub 16, and three journals 17 that protrude radially outward from an outer surface of the hub 16. The hub 16 is placed within the central cavity 14 of the housing 11, and the three journals 17 extend radially outward from the outer surface of the hub 16. The three journals 17 are evenly spaced in a circumferential direction around the outer surface of the hub 16 and can each be positioned within the track grooves 15 of the housing 11. The spider 12 is configured to move axially within the housing 11 and can tilt to allow angular displacement relative to the housing 11.

The power transmission shaft (not shown) can be connected to the hub 16 to rotate therewith. For example, the power transmission shaft can be inserted into a through hole 22 formed in the hub 16 and can be coupled thereto using a spline method.

The three bearing units 13 are each engaged to the three journals 17. Referring to FIGS. 2 and 3, the bearing unit 13 is positioned in the track groove 15 of the housing 11 while being engaged to the journal 17. The bearing unit 13 serves as a bearing between the housing 11 and the spider 12 and mediates power transmission. The bearing unit 13 engaged to the journal 17 is designed to move within the track groove 15 longitudinally, i.e., in a direction parallel to the axial direction of the housing 11. The movement of the bearing unit 13 within the track groove 15 allows for relative translational motion between the housing 11 and the spider 12. Also, the bearing unit 13 is engaged to the journal 17 to be tiltable relative to the journal 17, and the bearing unit 13 can thus change its tilt angle relative to the journal 17 during angular displacements between the housing 11 and the spider 12 and can move linearly simultaneously, enabling power transmission.

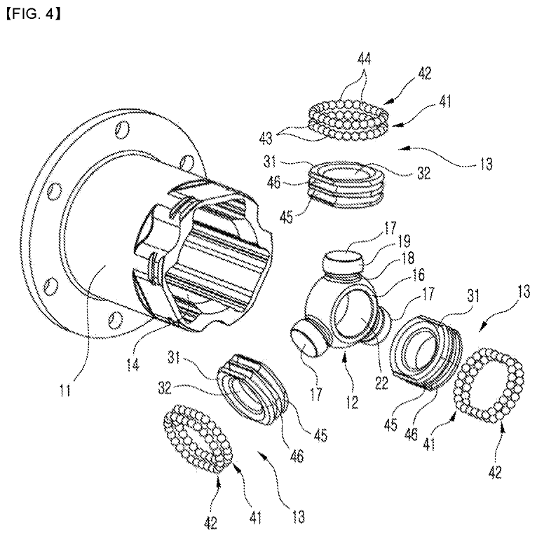

Referring to FIG. 4, the bearing unit 13 includes a track race 31 and ball arrays 41 and 42. The bearing unit 13 is positioned between the housing 11 and the spider 12, which are the power transmission components, playing functions as a bearing and serving as a medium for transmitting rotational power. On one hand, the bearing unit 13 is engaged to the journal 17 of the spider 12 to allow for relative movement of the spider 12 with respect to a longitudinal direction (radial direction in FIG. 2) of the journal 17 and tilting behavior, and on the other hand is designed to move linearly within the track groove 15 of the housing 11.

As shown in FIG. 4, the journal 17 may include a neck portion 18 connected to the hub 16 and a contact portion 19 that extends from a radial outer end of the neck portion 18. The contact portion 19 is the part that contacts the track race 31 and can be formed with an approximately convex curved surface. Specifically, the contact portion 19 can be formed as a spherical surface. Meanwhile, as shown in FIG. 4, the track race 31 may have a ring shape that surrounds the contact portion 19. The track race 31 may be equipped with a cylindrical through hole 32, within which the contact portion 19 of the journal 17 is be placed. By having the spherical contact portion 19 touch the inner surface of the cylindrical track race 31, relative tilting movement between the journal 17 and the track race 31 is enabled. The track race 31 is disposed in the track groove 15 of the housing 11 in a state of being engaged to the journal 17 of the spider 12 in a tiltable manner.

The first and second ball arrays 41 and 42 respectively include a plurality of first and second balls 43 and 44. As shown in FIG. 2, the two ball arrays 41 and 42 are positioned at different locations along a radial direction of the joint, i.e., along a length direction of the journal 17. That is, referring to FIG. 4, the ball array indicated by reference numeral 41 is positioned closer to the center of the joint than the ball array indicated by reference numeral 42. Redundant descriptions regarding the first ball array 41 and the second ball array 42 are omitted.

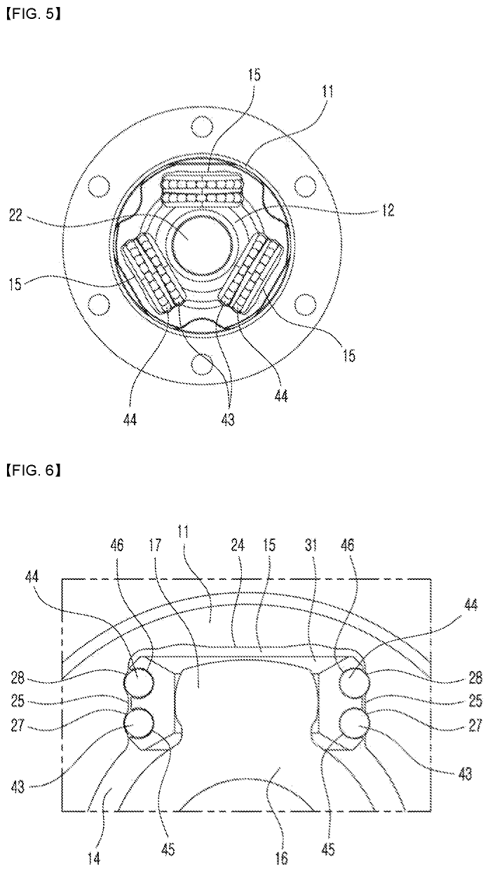

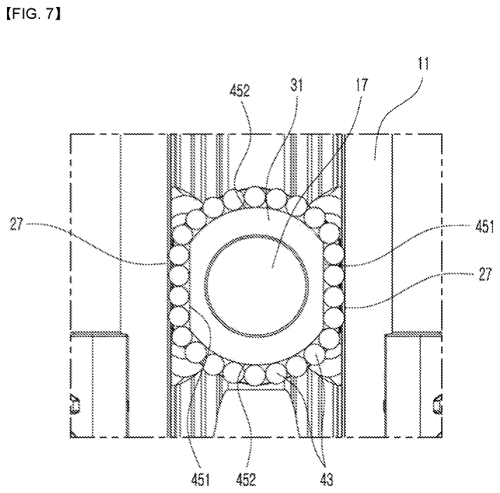

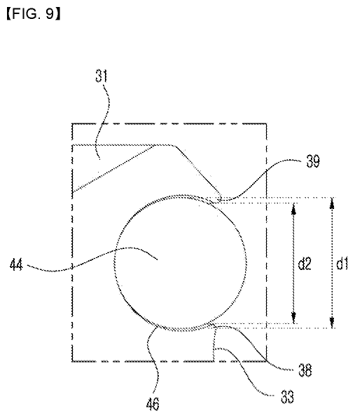

Referring to FIG. 6, the track groove 15 of the housing 11 forms a ceiling surface 24, and power transmission surfaces 25 that are disposed at both sides of the ceiling surface 24 to face each other in a circumferential direction. Referring to FIG. 8, the track race 31 is configured such that both portions among a peripheral surface 33 of the track race 31 that are positioned at circumferential direction of the joint face the power transmission surface 25 of the track groove 15 respectively. The balls 43 and 44 are positioned between the peripheral surface 33 of the track race 31 and the power transmission surface 25 of the track groove 15, acting as medium for power transmission.

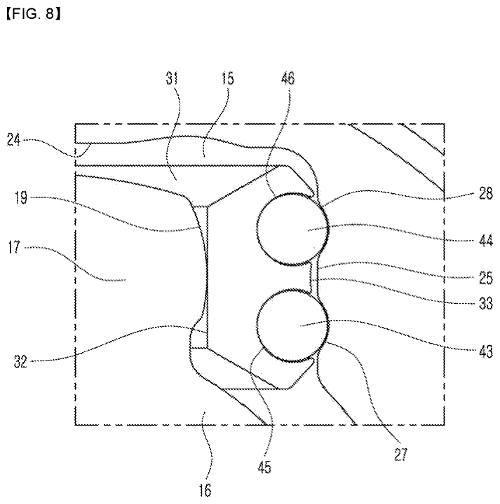

The first and second balls 43 and 44 are configured to circulate around the perimeter of the track race 31 during the operation of the joint. For instance, depending on the rotation direction and articulation angle of the housing 11 and spider 12, the first ball 43 can repeatedly rotate in a clockwise direction and in a counterclockwise direction, as shown in FIG. 7.

Referring to FIG. 4, the track race 31 forms inner ball grooves 45 and 46 for guiding the movement of the first and second balls 43 and 44, respectively, and the ball grooves 45 and 46 form circulation paths for the balls 43 and 44. The ball grooves 45 and 46 may be formed so that they run around the periphery of the track race 31 on the peripheral surface 33 of the track race 31, thus creating the circulation paths for the balls in a circumferential direction. As shown in FIGS. 6 and 8, the balls 43 and 44 are accommodated in the ball grooves 45 and 46 in such a way that portions thereof protrude outward from the ball grooves 45 and 46. In this connection, at least portions of the protruded portions of the balls 43 and 44 are accommodated in the outer ball grooves 27 and 28 formed on the power transmission surface 25 of the track groove 15. Thus, the movements of the balls 43 and 44 are guided while they are partially accommodated in both the ball grooves 45 and 46 of the track race 31 and the ball grooves 27 and 28 of the track groove 15.

By positioning two ball arrays 41 and 42 at different locations along the longitudinal direction of the journal 17 of the spider 12, each ball 43 and 44 of the ball arrays 41 and 42 contact the power transmission surface 25 of the housing 11 from different positions along the length of the journal 17. Compared to configurations where a single ball array creates a contact point or a cylindrical roller forms a broad contact area, this embodiment of the invention having two ball arrays can enlarge the contact area (the area between the two contact points) in a radial direction without significantly increasing the overall size of the constant velocity joint. This can reduce wobbling of the track race during joint operation and consequently improve GAF characteristics.

The ball grooves 45 and 46 comprises a pair of grooves 451 and 461 arranged to face each other in a circumferential direction of the joint and a pair of grooves 452 and 462 arranged to face each other in a longitudinal direction of the joint. The grooves 451 and 461 that are arranged to face each other in the circumferential direction of the joint are extended linearly and work in conjunction with the ball grooves 27 and 28 of the housing to guide the movement of the balls 43 and 44 involved in power transmission. The grooves 452 and 462 that are arranged to face each other in the longitudinal direction of the joint are extended in a curve to connect the grooves 451 and 461 facing each other in the circumferential direction, each independently forming a portion of the ball circulation path.

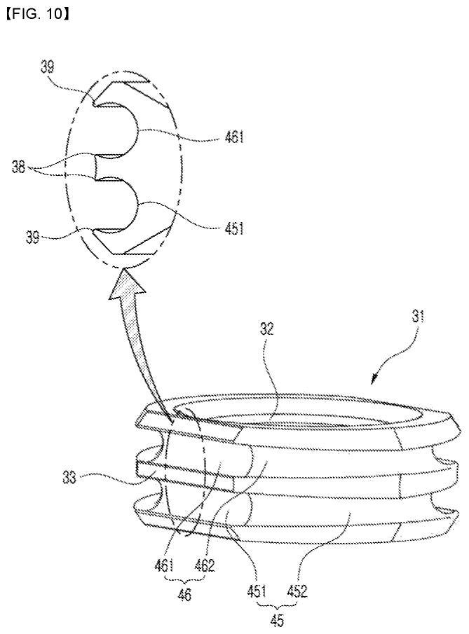

Referring to FIG. 9, the height d2 of the opening of the ball groove 46 formed on the peripheral surface 33 of the track race 31 is designed to be smaller than the diameter d1 of the ball 44 accommodated in the ball groove 46. This prevents the ball 44 from escaping from the ball groove 46. The ball 44 may have a spherical shape, and the ball groove 46 may have a cylindrical shape with a circular cross-section that has a diameter larger than that of the ball 44. At this point, by placing the center of the circle forming the cross-section of the ball groove 46 more inward (to the left in FIG. 9) than the opening, the height d2 of the opening of the ball groove 46 can be formed smaller than the diameter d1 of the ball 44 accommodated therein. As a result, as illustrated in FIG. 9, the opening of the ball groove 46 is formed by end portions 38 and 39 in a tapered shape of converging toward each other. For example, the track race 31 may be made of metal, and the tapered end portions 38 and 39 of the track race 31 may be formed by plastically deforming a flat portion through machining, pressing, rolling processes or the like.

The cross-section of the ball grooves 45 and 46 of a cylindrical shape has a shape of a circle with a portion removed, and a diameter of a circle forming the cross-section of the ball grooves 45 and 46 is greater than the diameter of the balls 43 and 44. As a result, each ball 43 and 44 contacts the track race 31 at a single point. This allows for stable torque transmission with minimal friction. Furthermore, the ball grooves 27 and 28 of the housing 11 also have a cross-section in the shape of a circle with a portion removed, and the diameter of the circle forming the cross-section of the ball grooves 27 and 28 is formed greater than the diameter of the balls 43 and 44. As a result, each ball 43 and 44 contacts the housing 11 at a single point. Meanwhile, in another embodiment of the present invention, the ball and track race, as well as the ball and the housing, may be configured to contact at two or more points.

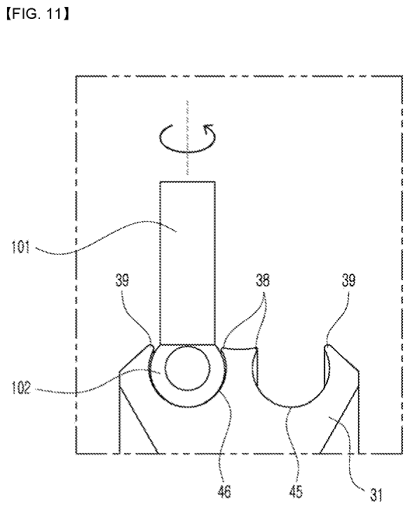

In FIG. 10, a track race 31 manufactured by an embodiment of the present invention is shown. Referring to FIG. 10, the track race 31 includes two ball grooves 45 and 46 formed at different locations, and each ball groove 45 and 46 can have straight grooves 451 and 461 forming a straight section and curved grooves 452 and 462 forming a curved section. Curved grooves 452 and 462 extend in a curve to connect the opposing straight grooves 451 and 461 with each other. A circulation path for balls 43 and 44 is formed by the connected straight grooves 451 and 461 and curved grooves 452 and 462. At this time, as shown within a dotted circle in FIG. 10, the track race 31 includes end sections 38 and 39 that are narrowed towards each other such that a height of the opening of the ball grooves 45 and 46 is smaller than a diameter of the balls 43 and 44 to prevent the balls 43 and 44 from escaping. Such end section 38 and 39 can be formed by a cutting process or a plastic deformation method, and manufacturing methods for forming such end section 38 and 39 according to embodiments of the present invention are described in sequence below.

Referring to FIG. 11, the ball grooves 45 and 46 can be formed by a cutting process using a cutting tool 101. For example, the cutting tool 101 may be a cutter that rotates while performing the cutting and may have a cross-sectional shape similar to that of the ball groove. As shown in FIG. 11, the cutting tool 101, while rotating in a direction of an arrow shown in FIG. 11, drills a hole in a peripheral surface of the track race 31 and subsequently rotates along the peripheral surface to form the ball grooves 45 and 46. Through this method, the end sections 38 and 39 that narrow towards each other to form the opening of the ball grooves 45 and 46, can be created.

After the cutting process using the cutting tool 101, a hardening heat treatment can be performed. In this regard, the heat treatment can be carried out through carburizing heat treatment or quenching and tempering treatment. Additionally, before machining with the cutting tool 101, it is preferable to shape the intermediate workpiece through forging into a shape similar to the final shape of the track race.

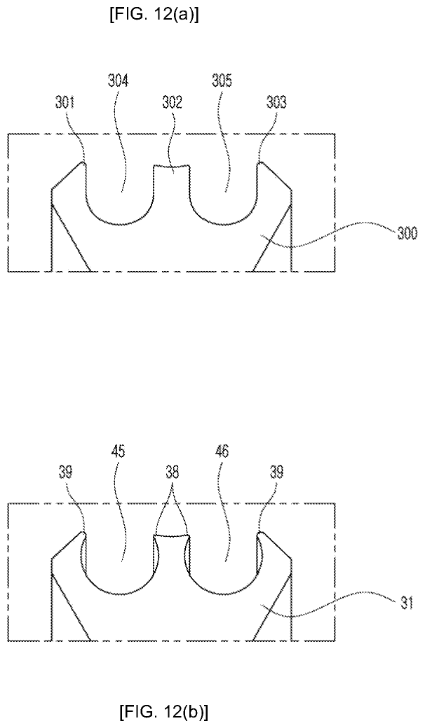

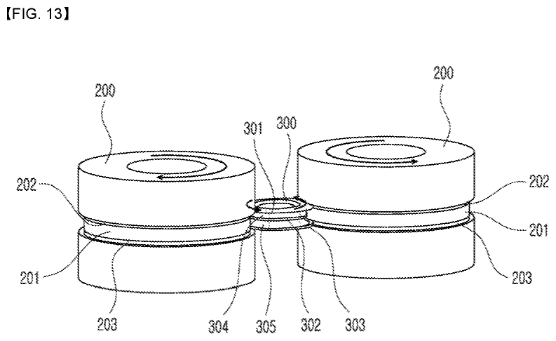

In FIG. 12, a process of forming the end sections 38 and 39 that creates the opening of the ball grooves 45 and 46 of the track race 31 through plastic deformation is illustrated. In FIG. 12(a), an intermediate workpiece 300 before the section is formed is shown, and the intermediate workpiece 300 is manufactured identically to the track race 31 apart from the and sections 38 and 39. The peripheral surface of the intermediate workpiece 300 is equipped with three protrusions 301, 302, and 303 and grooves 304 and 305 formed therebetween. The grooves 304 and 305 of the intermediate workpiece 300 have a shape in which an entrance portion forming the opening extends flat with respect to an inner space, as shown in FIG. 12(a), and the narrowed end portions 38 and 39 of the track race 31 are obtained when the protrusions 301, 302, and 303 undergo plastic deformation as shown in FIG. 12(b). The intermediate workpiece 300 can be formed through machining or forging.

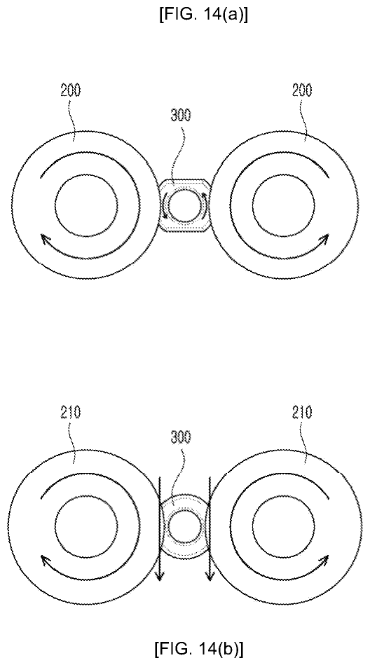

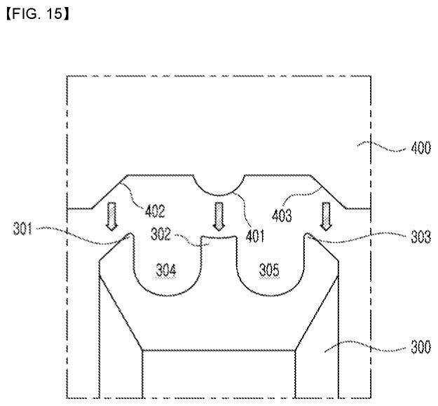

In FIG. 13, a method is illustrated in which the protrusions 301, 302, and 303 of the intermediate workpiece 300 are plastically deformed by a rolling process to form the end sections 38 and 39 of the track race 31. Referring to FIG. 13, the intermediate workpiece 300 can be processed using two opposing rollers 200, and each roller 200 includes two forming grooves 202 and 203 for shaping the outer protrusions 301 and 303 of the intermediate workpiece 300 and a forming surface 201 for forming the middle protrusion 302. As shown in FIG. 13, when the intermediate workpiece 300 is placed between the two rollers 200 and the rollers 200 rotate in the directions indicated by the arrows, the intermediate workpiece 300 rotates in a direction indicated by an arrow, leading to the plastic deformation of the protrusions 301, 302, and 303, thus forming the narrowed end sections 38 and 39 of the track race 31. Furthermore, as shown in FIG. 14, separate rollers 200 and 210 can be employed to form the end sections of the openings for the straight ball grooves 451 and 461 and the curved ball grooves 452 and 462 of the track race 31. FIG. 14(a) shows the process of forming the end sections 38 and 39 that creates the opening for the curved ball grooves 451 and 461 using the rollers 200, and FIG. 14(b) shows using another roller 210 to form the end sections 38 and 39 for the straight ball grooves 452 and 462. The two rollers 200 and 210 overall resemble each other but have different forming part shapes based on the end sections 38 and 39 that form the openings for the straight grooves 451 and 461 and the curved grooves 452 and 462. The arrows in FIG. 14 indicate the rotation direction of the rollers 200 and 210 and the intermediate workpiece 300 during the rolling process.

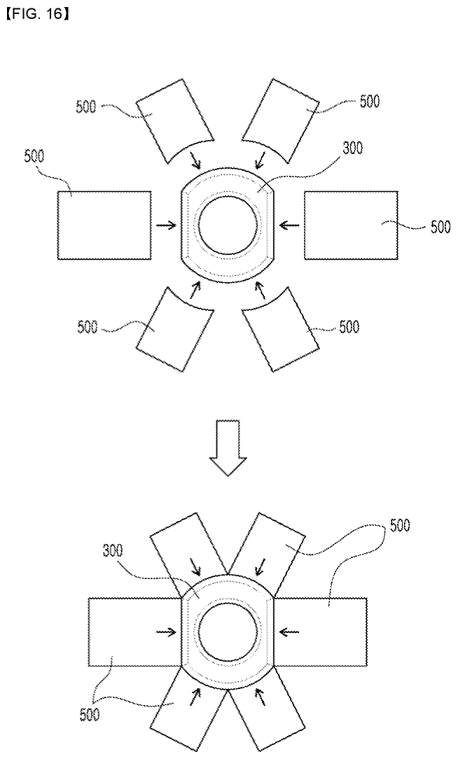

In FIG. 15, a method is depicted in which the protrusions 301, 302, and 303 of the intermediate workpiece 300 are plastically deformed using a press die 400 to form the end sections 38 and 39 of the track race 31. The press die 400 is equipped with forming parts 402, 401, and 403 capable of respectively deforming the protrusions 301, 302, and 303 of the intermediate workpiece 300. The press die 400 is moved in a direction indicated by the arrows in FIG. 15 to apply pressure to the intermediate workpiece 300, resulting in the plastic deformation of the protrusions 301, 302, and 303.

In FIG. 16, a method is illustrated where the protrusions 301, 302, and 303 of the intermediate workpiece 300 are plastically deformed using a swaging die 500 to form the end sections 38 and 39 of the track race 31. As shown in FIG. 16, a plurality of swaging dies 500 and a mandrel (not depicted) can be used to cause plastic deformation of the protrusions 301, 302, and 303 of the intermediate workpiece 300.

The rolling process, press process, and swaging process described above can each be used to plastically deform the intermediate workpiece, after which a hardening heat treatment can be performed.

In this regard, the heat treatment can be carried out through carburizing hardening heat treatment or quenching and tempering. Additionally, it is preferable to shape the intermediate workpiece similar to the final shape of the track race through forging before processing for plastic deformation.

The embodiments of the invention have been described above, but the scope of the rights of the invention is not limited thereto. It includes all changes and modifications that are easily made by a person with ordinary knowledge in the technical field to which the invention belongs and are recognized as equivalent.

### INDUSTRIAL APPLICABILITY

The present invention can be applied to a manufacturing method of a constant velocity joint, such as a tripod, of a vehicle, indicating its industrial applicability.

1. A manufacturing method of a track race disposed between a housing and a spider of a tripod constant velocity joint and having a ball groove an opening of which is narrowed, wherein an end section for forming the narrowed opening of the ball groove is formed on an intermediate workpiece for manufacturing the track race through machining process or plastic deformation process.

2. The manufacturing method of claim 1, wherein the end section is formed through machining using a cutting tool.

3. The manufacturing method of claim 1, wherein the end section is formed through plastic deformation process by one of a rolling process using a roller, a press process using a press die, or a swaging process using a swaging die.

4. The manufacturing method of claim 1, further comprising performing a hardening heat treatment after the machining process or the plastic deformation process.

5. A track race manufactured by a manufacturing method according to any one of claims 1 to 4.

6. A tripod constant velocity joint comprising:
a housing having a tubular shape that forms three track grooves arranged along a circumferential direction;
a spider having a hub placed inside the housing and three journals respectively extending radially outward from the hub and respectively arranged in the track grooves; and
three bearing units respectively engaged to the journals,
wherein each of the bearing units comprises a track race that is arranged in the track groove in a state of being tiltably engaged to the journal and a plurality of balls disposed between a peripheral surface of the track race and power transmission surfaces facing each other in a circumferential direction to form the track grooves, and
wherein the track race comprises a ball groove for at least partially accommodating the plurality of the balls,
wherein the track race is provided with an end section for forming a narrowed opening of the ball groove, and
wherein the end section is formed by a manufacturing method according to any one of claims 1 to 4.

7. The tripod constant velocity joint of claim 6, wherein the ball groove is configured to form a ball circulation path in which the plurality of the balls can circulate along a periphery of the track race.
